(19) United States
(12) Patent Application Publication
(10) Pub. No.: US 2013/0054611 A1
(43) Pub. Date: Feb. 28, 2013

(54) APPARATUS AND METHOD FOR PROCESSING PARTITIONED DATA FOR SECURING CONTENT

(71) Applicant: Seong-Han LEE, Seoul (KR)

(72) Inventor: Seong-Han LEE, Seoul (KR)

(73) Assignee: PANTECH CO., LTD., Seoul (KR)

(21) Appl. No.: 13/336,711

(22) Filed: Dec. 23, 2011

(30) Foreign Application Priority Data
Aug. 25, 2011 (KR) 10-2011-0085324

(51) Int. Cl. G06F 17/30; G06F 7/00

(52) U.S. Cl. 707/741; 707/809; 707/E17.083

(57) ABSTRACT

An apparatus to process partitioned data includes a storage unit to store a first data portion of a data file; a communication unit to receive a second data portion of the data file from a device in response to an authentication between the apparatus and the device; and a recovery processing unit to obtain the data file, by merging the first data portion and the second data portion of the data file using partition information.

### CROSS-REFERENCE TO RELATED APPLICATION

This application claims priority from and the benefit under 35 U.S.C. §119(a) of Korean Patent Application No. 10-2011-0085324, filed on Aug. 25, 2011, which is hereby incorporated by reference for all purposes as if fully set forth herein.

### BACKGROUND

1. Field

The following description relates to an apparatus and method for partitioning data for enhancing network computing security, and more particularly, to an apparatus and method for partitioning data and for processing partitioned data.

2. Discussion of the Background

With an introduction of a cloud computing technology, various services, such as storing data, using a network and content, etc., as well as various platforms and infrastructure may be provided by a remote server connected through the Internet, users' important content, personal information, etc., may be stored in the remote server through the Internet.

In a cloud computing environment, data security has been addressed mainly through technologies of protecting identifications (IDs) and passwords and technologies of encrypting data. However, in the cloud computing environment, mobile terminals frequently communicate with a remote server by storing and retrieving important data to and from the remote server. Thus, there still have been risks of leakage of ID/password encryption algorithms due to malicious hacking, etc. The leakage of the encryption algorithms may destroy the security of the remote server providing cloud computing service, or may cause leakage of data stored in the remote server.

### SUMMARY

Exemplary embodiments of the present invention provide an apparatus and method for processing partitioned data for enhancing network security. The apparatus and method may prevent recovery of original data when data leakage occurs in a server by partitioning data and storing the partitioned data separately, thereby storing and processing data in a network environment, such as a cloud computing environment.

Additional features of the invention will be set forth in the description which follows, and in part will be apparent from the description, or may be learned by practice of the invention.

An exemplary embodiment of the present invention provides an apparatus to process partitioned data, including a storage unit to store a first data portion of a data file; a communication unit to receive a second data portion of the data file from a separate device in response to an authentication between the apparatus and the separate device; and a recovery processing unit to obtain the data file, by merging the first data portion and the second data portion of the data file using partition information.

An exemplary embodiment of the present invention provides a server to process partitioned data, including a storage unit to store a first data portion of a data file; a communication unit to receive identification information of a terminal, and to transmit the first data portion of the data file to the terminal in response to an authentication of the terminal; and an authentication unit to authenticate the identification information of the terminal.

An exemplary embodiment of the present invention provides a method for processing partitioned data, including partitioning the data file into a first data portion and a second data portion; generating partition information used for merging the first data portion and the second data portion, based on a partitioning method; and storing the first data portion in a first storage and storing the second data portion in a second storage. The partition information includes an authentication protocol between the first storage and the second storage.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a cloud computing environment according to an exemplary embodiment of the present invention.

FIG. 2 is a diagram illustrating a terminal to partition data according to an exemplary embodiment of the present invention.

FIG. 3A and FIG. 3B are views illustrating a method for partitioning content according to an exemplary embodiment of the present invention.

FIG. 4 is a view illustrating a method for partitioning content according to an exemplary embodiment of the present invention.

FIG. 5 is a view illustrating a method for partitioning content according to an exemplary embodiment of the present invention.

FIG. 6 is a diagram illustrating a cloud server according to an exemplary embodiment of the present invention.

FIG. 7 is a flowchart illustrating a method for partitioning content according to an exemplary embodiment of the present invention.

FIG. 8 is a flowchart illustrating a method for partitioning content based on a security level according to an exemplary embodiment of the present invention.

FIG. 9 is a flowchart illustrating a method for recovering partitioned content according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X).

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

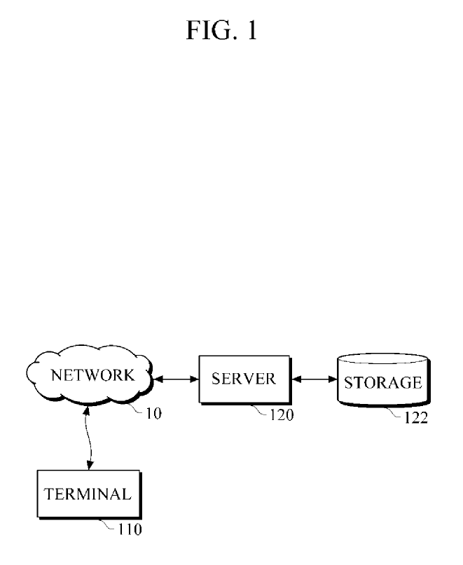

FIG. 1 is a diagram illustrating a cloud computing environment according to an exemplary embodiment of the present invention.

In the cloud computing environment, a terminal 110 is connected to a server 120 through a network 10. The server 120 may be a cloud server. The server 120 stores various data including various content in a storage 122. The content may include various types of format, such as text, video, audio, multimedia, etc. Also, the content may be multimedia content that can be shared with a plurality of users, and the data may include personal information accessible only by a specific user, business files, and so on. Further, the content may include private content created in the terminal 110 by a user, or public content provided by the server 120 or another content provider. The private content and the public content may be stored in the terminal 110, for example, in a temporary storage or a permanent storage.

In FIG. 1, the server 120 is shown as a single device; however, the server 120 may be a server group including a plurality of servers. If the server 120 is a server group including a plurality of servers, the servers may be distributed over different geographical locations and connected through the network 10.

The terminal 110 may be a personal computer, a set-top box, a laptop computer, a mobile phone, a smart phone, a Personal Digital Assistant (PDA), a Portable s Multimedia Player (PMP), a MP3 (MPEG-3) player, a fixed electronic device, a mobile electronic device, or the like. In FIG. 1, the terminal 110 is shown as a single device, however, in the cloud computing environment, a plurality of terminals may be connected to the server 120 through the network 10.

The terminal 110 or the server 120 may serve, when storing content, as a content security apparatus for providing security according to a content partitioning method. Hereinafter, the terminal 110 may operate as a content security apparatus. The server 120 or another device (not shown) may serve as the content security apparatus.

The terminal 110 may store content (or data) in a storage (not shown) after partitioning the data or without partitioning the data. In the following description, applying partition with security may be referred to as partitioning content for security. In the following description, storing content after partitioning may be referred to as a partition-with-security mode, and storing content without partitioning may be referred to as a normal storage mode.

The terminal 110 may determine, when storing content, whether to partition the content, and determine a security level of the content. Then, the terminal 110 may partition the content into a first content part (or “first data portion”) to be stored in the terminal 110 and a second content part (or “second data portion”) to be stored in the server 120 based on the security level, and transmits the second content part to the server 120 so that the server 120 can store the second content part.

The terminal 110 may apply partition with security to all received content. If partition information indicating whether to apply partition with security to corresponding content is included or set in the content, the terminal 110 may determine whether to partition the content, according to the partition information.

Before storing content to the server 120, the terminal 110 may display a partition determination request message on a screen for a user of the terminal 110 to determine whether to apply partition with security to the content, and perform partition with security according to a response from the user. For example, if the user inputs an input allowing the partition of the content, the terminal 110 may apply partition with security to the content, and if the user inputs an input rejecting the partition of the content, the terminal 110 may store the content in the server 120 without partitioning the content.

Further, the terminal 110 may determine whether to apply partition with security to content based on partition conditions. The partition conditions may provide information about whether the partition with security has to be applied to the content and/or information about a security level for the partition of the content.

The partition conditions may include a content type, time information of the storage of the content, content price, content size, content's author, content name, current location of a terminal, available network types, etc. The security level of content may be determined based on individual item of the partition conditions or the number of the partition conditions that the content satisfies.

The terminal 110 stores the second content part in the server 120. If an operating system (OS) of the terminal 110 sets a portion of the memory area of the server 120 to a virtual memory, the portion of the memory area of the server 120 may be regarded as an expanded memory area for the terminal 110, and the terminal 110 may store the second content part in the expanded memory area. In this case, if the terminal 110 stores content, retrieves partitioned content, or modifies the partitioned content, the terminal 110 performs data processing using the internal memory area of the terminal 110 and the memory area of the server 120 set to a virtual memory, as an integrated memory area.

The content may be partitioned and stored for security without a user's command to partition and store the content. By partitioning and storing content in the server 120, the terminal 110 may not have a large storage capacity for internal memory, which may lead to a reduction of manufacturing costs of the terminal 110. A content security apparatus and method based on a scheme of partitioning and storing content may be implemented by a high-speed wireless communication network, such as Long Term Evolution (LTE) and a high-speed access point (AP).

In the normal storage mode, no partition with security is performed, and content may be stored in the terminal 110 or in the server 120. Whether to store content in the terminal 110 or in the server 120 may be determined using various methods. For example, if the size of content is smaller than a defined threshold value, the content may be stored in the terminal 110, and if the size of content is larger than the threshold value, the content may be stored in the server 120. Further, if the usage frequency of the content is higher than a defined reference frequency, the content may be stored in the terminal 110, and if the use frequency of content is less than or equal to the reference frequency, the content may be stored in the server 120.

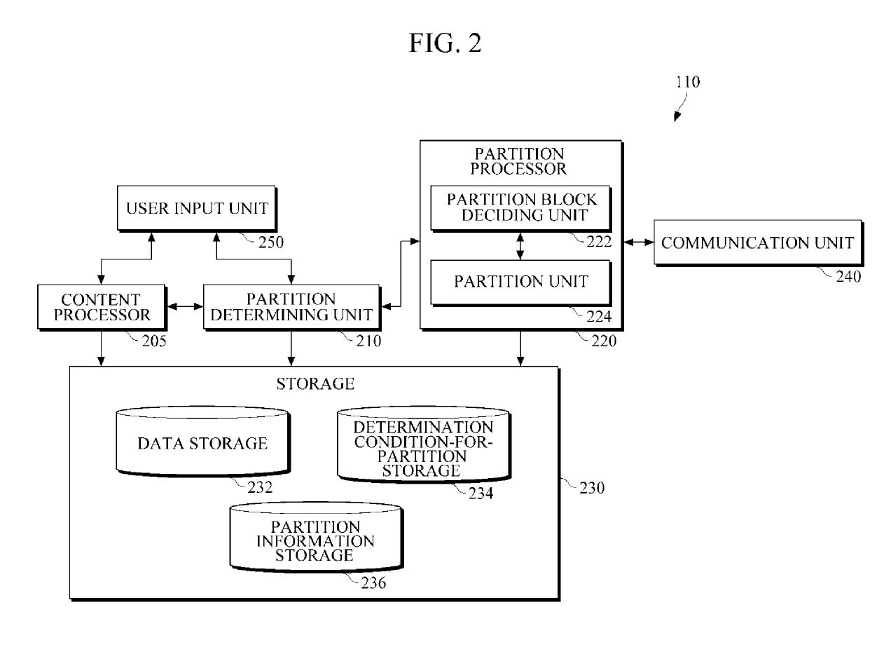

FIG. 2 is a block diagram illustrating a terminal to partition data according to an exemplary embodiment of the present invention.

Referring to FIG. 2, the terminal 110 includes a content processor 205, a partition determining unit 210, a partition processor 220, a storage 230, a communication unit 240, and a user input unit 250. The content processor 205, the partition determining unit 210, and the partition processor 220 may be implemented as separate processors or as an integrated processor.

The content processor 205 processes various data and content. The content processor 205 may create, edit, retrieve, and reproduce content according to user input signals received from the user input unit 250. For these operations, the content processor 205 may drive an application for processing and reproducing content. As described above, the content may be received/downloaded from an external device or created by a user of the terminal 110.

The content processor 205 uses partition information (the partition information will be described below in more detail) to receive the second content part from the server 120 and combine the second content part with the first content part stored in the storage 230, thereby recovering original content existing before partitioning.

The partition determining unit 210 may operate if the content processed by the content processor 205 is created or stored or if a message informing that the content is stored is received from the content processor 205. The partition determining unit 210 determines whether to partition the content according to partition conditions. The partition conditions may be predetermined, or may be set according to a user setting or selection, or may be set according to usage characteristics by a user, for example. For example, the partition determining unit 210 may determine to partition the content if the content satisfies at least one of the partition conditions. Here, the partition conditions may include at least one of content characteristics and the state of the terminal 110. The content characteristics may include at least one of a content type, time information of the storage of the content, content price, content's author, content size, and content name, and the like. The state of the terminal 110 may include at least one of a current location of the terminal 110 and a type of a network which the communication unit 240 uses.

Further, the partition determining unit 210 may determine a security level of the content. The partition determining unit 210 may determine to apply a higher security level to content that satisfies more than a determined number of partition conditions among the partition conditions when partitioning the content. For example, the partition determining unit 210 may apply a security level “high” to content that satisfies four or more partition conditions among time information of the storage of the content, content price, content's author, content size, content name, current locations of terminal, and available network type.

Further, the partition determining unit 210 may activate or deactivate at least one of the partition conditions. That is, the partition determining unit 210 may decide a security level of the content based on one or more activated partition conditions among the partition conditions. The activation or deactivation of the partition conditions may be determined based on a user input signal or a current system state of the terminal 110. Further, if content to be stored satisfies only a partition condition B when a partition condition A is in an activated state and the partition condition B is in a deactivated state, the partition determining unit 210 may determine to store the content in the normal storage mode, without partitioning.

The partition determining unit 210 may use a security value calculated with respect to partition conditions which the content satisfies to determine a security level of content to be partitioned. For example, the partition determining unit 210 may apply a higher security level to content having a security value higher than a reference security value.

In this case, the partition conditions may have weights. The partition determining unit 210 calculates the security value using weights of the partition conditions. For example, it may be assumed that a partition condition C has a weight of 1, a partition condition D has a weight of 0.3, a partition condition E has a weight of 0.5, content #1 satisfies the partition condition C, and content #2 satisfies the partition condition D. In this case, the partition determining unit 210 may apply a higher security level to the content #1 since the weight of the partition condition C which the content #1 satisfies is greater than the weight of the partition condition D which the content #2 satisfies.

If content satisfies a plurality of partition conditions, the partition determining unit 210 may determine the greatest weight among the satisfying partition conditions as a security value of the partition conditions for the content. For example, it may be assumed that a partition condition C has a weight of 1, a partition condition D has a weight of 0.3, a partition condition E has a weight of 0.5, content #1 satisfies the partition condition C, and content #2 satisfies the partition conditions D and E. Then, the security level of content #2 is 0.5. Further, the partition determining unit 210 may determine the sum of weights of the satisfying partition conditions as a security value of the partition conditions for the content. For example, it may be assumed that a partition condition C has a weight of 1, a partition condition D has a weight of 0.3, a partition condition E has a weight of 0.5, content #1 satisfies the partition condition C, and content #2 satisfies the partition conditions D and E. Then, the security level of content #2 is 0.8. In this case, the partition determining unit 210 may apply higher security level to the content #1 than the content #2 since the sum of weights of partition conditions which the content #1 satisfies is greater than the sum of weights of partition conditions which the content #2 satisfies, even though the content #2 satisfies more partition conditions than the content #1.

The partition processor 220 may partition content into a first content part to be stored in the terminal 110 and a second content part to be stored in the server 120, according to a security level of the content. The partition processor 220 determines the size of a unit block which is a partition unit of the content, according to a security level of the content. If the content has the higher security level, the partition processor 220 determines the unit block to be a smaller size. Further, the partition processor 220 may select an appropriate partitioning method according to a security level of content. In this case, the partition processor 220 may apply a more complicated partitioning method to content having a higher security level to partition the content.

After the content is partitioned, partition information indicating the state of the partitioned content is created. The content and format of the partition information are determined based on the content partitioning method.

The storage 230 may include a data storage 232, a determination conditions-for-partition storage 234 and a partition information storage 236. The storage 230 may be an internal memory installed in the terminal 110 or an external memory detachably connected to the terminal 110.

The data storage 232 stores data to operate the terminal 110, applications, and content that are processed and managed in the terminal 110, etc. The data storage 232 stores unpartitioned content which is stored in a normal storage mode, and first content parts of partitioned content in a partition-with-security mode. The unpartitioned content and the first content parts may be stored in different spaces of the data storage 232.

The determination conditions-for-partition storage 234 stores partition conditions. The partition conditions may be predetermined and the partition determining unit 210 may determine whether to partition content and determine a security level for partitioning the content, based on the partition conditions.

The partition information storage 236 stores partition information. The partition information may be created for combining corresponding first content part and corresponding second content part. Accordingly, data indicating partition information or a name of each partition information file may be created to reflect a name or identification information of the corresponding partitioned content. If content is modified by editing or correcting and the modified content may be repartitioned in a different format, partition information about the modified content may be updated accordingly.

The partition information may include at least one piece of information regarding a size of a unit block which is a partition unit of content, unit block index information (or, information regarding an arrangement order of unit blocks) for a first content part, unit block index information (or, information regarding an arrangement order of unit blocks) for a second content part. The unit block index information (or, information regarding an arrangement order of unit blocks) for the first content part may include identification information of unit blocks configuring the first content part or information regarding an arrangement order of the unit blocks. If the unit block index information for the first content part is used to determine unit block index information for the second content part, or vice versa, the partition information may include one of the unit block index information for the first content part and the unit block index information for the second content part.

The content and formats included in the partition information may depend on a content partitioning method that is determined according to a security level of the corresponding content. The partition information may be created or modified in various formats as long as the partition information can be used in recovering the partitioned content.

The partition information may be stored in the terminal 110 and/or the server 120. Further, the partition information may be partitioned into first partition information and second partition information and the first partition information and the second partition information may be stored in the terminal 110 and the server 120, respectively.

The communication unit 240 communicates with the server 120 (see FIG. 1) through a network 10. The communication unit 240 may include one or more wired/wireless network interfaces. The second content part of the partitioned content may be transmitted to the server 120 through the communication unit 240 and stored in the server 120.

The user input unit 250 receives a user's input, and may be configured to include one or more of a key pad, a touch panel, a mouse, a keyboard, or the like. The terminal 110 may include one or more of various output devices (not shown), such as a display, a speaker, etc., for outputting the results of processing on content or operating states with respect to the content partition to the user.

Hereinafter, a process in which the partition determining unit 210 determines whether to apply partition with security according to partition conditions will be described.

As described above, the partition conditions may include a content type, time information of the storage of content, content price, content size, content's author, content name, current location of the terminal, an available network type, etc. First, the partition condition regarding the content type and a method of determining whether to apply partition with security based on the content type will be described, below.

The partition determining unit 210 may determine whether to apply partition with security to content based on a data type of the content or a file type of the content. The partition conditions may be applied according to a plurality of hierarchical conditions. For example, the partition condition regarding a content type may be determined as shown in Table 1.

<Partition Condition Regarding Content Type>

TABLE 1

| First Hierarchical Condition | Second Hierarchical Condition |
|---|---|
| (Content type) | (Content price, content size, author, etc.) |
| App (application) | Paid |
| Multimedia Content | Paid |
| | Beyond Threshold Size |
| Document | Document Application Type (a type of a |
| | word processing application) |
| | Document Author |

To determine whether to partition content, the partition determining unit 210 determines whether the content satisfies a first hierarchical condition among a plurality of first hierarchical conditions based on a type of the content, and then determines whether the content satisfies a second hierarchical condition that is a secondary condition depending on a result of the first hierarchical condition. If the content satisfies both the first and second hierarchical conditions, the partition determining unit 210 may determine that the content is to be partitioned. The hierarchical conditions may be predetermined, or set according to other criteria.

For example, if a content type of content to be stored is “App” which satisfies the first hierarchical condition, the partition determining unit 210 may determine whether the “App” is “Paid” which satisfies the second hierarchical condition or “Free”. If the “App” is “Paid” (a non-free application), the content is determined to be partitioned. Accordingly, if content to be stored is a free App (that is, if the content satisfies the first hierarchical condition while not satisfying the second hierarchical condition), the partition determining unit 210 may enter into the normal storage mode to store the content without partitioning the content.

If a content type of content to be stored is multimedia data, such as video and audio, which satisfies the first hierarchical condition, the partition determining unit 210 may determine whether the content is “paid” content or content larger than a threshold size. If the content is “paid” content or the size of the content is larger than the threshold size, the content satisfies the second hierarchical condition and it is determined that a partition with security is to be applied to the content. Meanwhile, if content to be stored satisfies the first hierarchical condition but does not satisfy the second hierarchical condition, i.e., multimedia content is “free” content or content below the size, the partition determining unit 210 may enter into the normal storage mode to store the content without partitioning the content.

If a content type of content to be stored is document, which satisfies the first hierarchical condition, the partition determining unit 210 may determine whether the document is created by a specific document processing application (for example, a word processing application such as MS Office®). If the document has a specific format indicating that the document is created by the specific document processing application, the content satisfies the second hierarchical condition, and the content is determined to be partitioned. Further, if a type of content to be stored is document, the partition determining unit 210 may determine whether to partition the content based on the author (or the source) of the document. For example, if content to be stored is a published document that is shared on the Internet, the partition determining unit 210 may store the content in the normal storage mode.

As discussed hereinabove, two hierarchical conditions have been described as an example of applying partition conditions, however, three or more partition conditions may be configured in a hierarchical form to determine whether to apply partition with security. Further, a determination whether to partition content may be determined in more various methods according to partition condition settings. For example, a determination whether to partition the content may be based on a primary partition condition, i.e., the content type, and a partitioning method may be determined based on a security value calculated based on secondary partition conditions, i.e., time information of the storage of content, content price, content size, content's author, content name, current location of the terminal, an available network type.

Further, the partition determining unit 210 may determine whether to apply partition with security, based on the location of the terminal 110. The location information of the terminal 110 may be obtained using GPS information of the terminal 110.

If the terminal 110 is determined to be located in a specific location, such as a secured location (i.e., the user's office), the partition determining unit 210 may determine that partition with security is to be applied to all content to be stored, regardless of content types, etc. If the location of the terminal 110 is not located within a secured location, the partition determining unit 210 may store content to be stored in the normal storage mode or display an input request message for the user to determine whether to apply partition with security to the corresponding content.

Further, the partition determining unit 210 may determine whether to apply partition with security, based on time information of the storage of content. Time slots may be selected as secured time slots. If a storage request for content occurs within the secured time slots, the partition determining unit 210 may determine to partition the content before storing the content. For example, the partition determining unit 210 may determine that all content created or to be stored in a defined time period, the secured time slots (for example, in a work time), is to be partitioned. Further, the partition determining unit 210 may store all content that is created or to be stored in an unsecured time slot in the normal storage mode, or may display an input request message to a user to determine whether to apply partition with security to the corresponding content.

Further, the partition determining unit 210 may determine whether to apply partition with security to content, based on a type of a network to which the terminal 110 is currently connected. For example, the partition determining unit 210 may recognize the type of a network to which the communication unit 250 is currently connected, and apply partition with security to all content to be stored if the network is a secured network, i.e., a company's Intranet or a company's Virtual Private Network (VPN).

Further, the partition determining unit 210 may determine whether to apply partition with security to content to be stored, based on the name of the content. If a security identifier, such as a specific word, phrase and characters indicating privacy of content or indicating the type of content, is included in content or in the name of content, the partition determining unit 210 may determine to partition the content. For example, the partition determining unit 210 may identify a specific word or phrase (for example, “report”, “yearly”, “analysis”, “consultation”, etc.) or specific characters (for example, s_XXX.doc, XXX_S.XLS, etc.) included in the name of content to be stored. If the content includes the specific word, phrase, or characters, the partition determining unit 210 determines that a partition with security is to be applied to the content.

Further, the user of the terminal 110 may select a security level for a data file to be stored as secured content having a first security level, a security identifier corresponding to the first security level may be added to partition information of the data file in response to the user's selection. For example, when creating or receiving a data file or content, the user may select the first security level for the data file and a security identifier corresponding to the first security level may be added to the partition information of the data file. Then, the data file may be partitioned into a first content part and a second content part by applying a partitioning method corresponding to the fist security level.

Further, the partition determining unit 210 may determine whether the size of content to be stored is larger than a threshold size. If the size of the content to be stored is larger than the threshold size, a partition with security is to be applied to the content. The threshold size may be an initially set value, i.e., a default value set initially in the terminal 110; however, the value of the threshold size may be changed by a user or according to a procedure implemented by the server or an administrator, for example.

If the partition determining unit 210 receives a user input about partition conditions that are to be used to decide a security level, the partition determining unit 210 may create a user input screen for allowing the user to set at least one partition condition, and provide the user input screen to the user. Also, the partition determining unit 210 may create a user input screen for allowing the user to change a threshold value (for example, the predetermined size) regarding at least one partition condition, and provide the user input screen to the user.

In this way, the partition determining unit 210 may determine whether to apply partition with security to content to be stored, and determine a security level of the corresponding content based on one or more of partition conditions. The partition determining unit 210 may apply a higher security level to content that satisfies more partition conditions among the partition conditions.

For example, it may be assumed that security levels for content are classified into three levels of “high”, “middle”, and “low”. In this case, if certain content satisfies three or more of partition conditions, the partition determining unit 210 may apply the security level “high” to the content. If certain content satisfies two of the partition conditions, the partition determining unit 210 may apply the security level “middle” to the content, and if certain content satisfies one of the partition conditions, the partition determining unit 210 may apply the security level “low” to the content. The number of security levels that can be classified is not limited to three, and the number of partition conditions that content may satisfy to apply a certain security level also may vary.

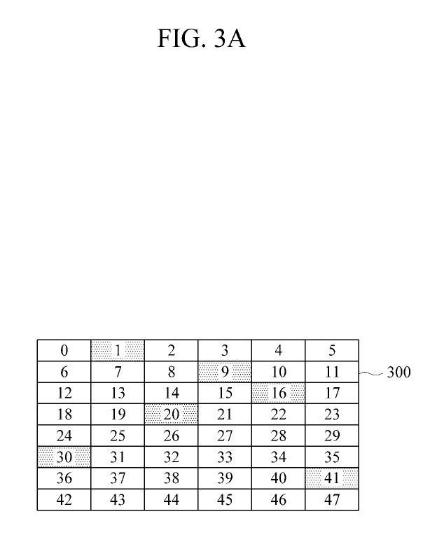

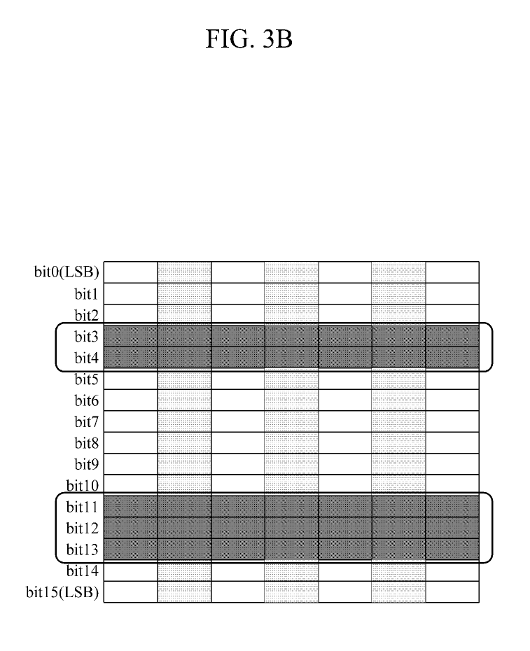

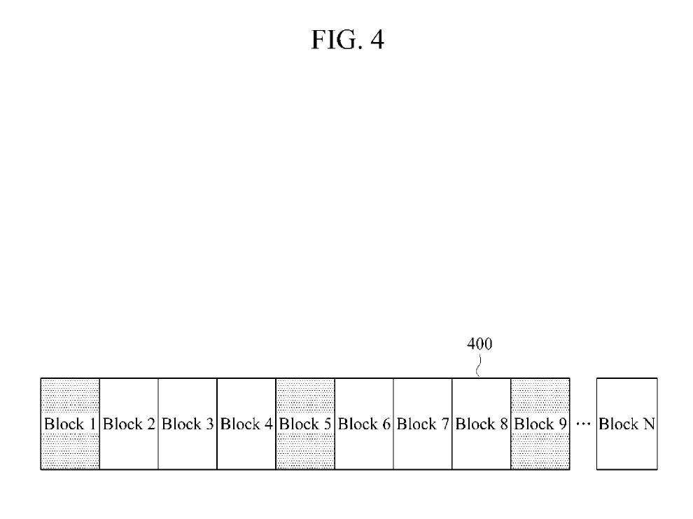

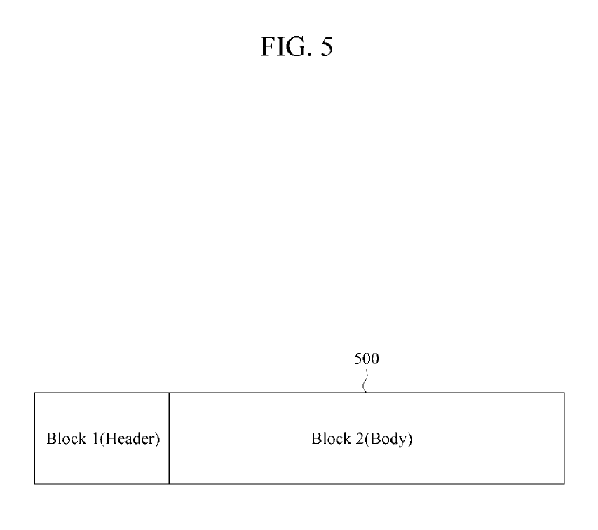

Hereinafter, when security levels are classified into three, examples of content partitioning methods according to the each security level will be described with reference to FIG. 3, FIG. 4, and FIG. 5.

FIG. 3A and FIG. 3B are views illustrating a method for partitioning content according to an exemplary embodiment of the present invention.

If content is classified as a security level “high”, the partition processor 220 partitions the content into first unit blocks, assigns an index to each first unit block, and determines at least one first unit block corresponding to an index that is an arbitrary random number, as a first content part. The first unit block may be in unit of word or byte. The partition processor 220 may apply a random number generator to unique hardware identification information of the terminal 110, thus generating the arbitrary random number. The random number generator may generate a random number based on the hardware identification information of the terminal 110. Also, the partition processor 220 may generate, as partition information, at least one of information regarding the size of the first unit block, unit block index information of the first content part, and unit block index information of a second content part, and store the partition information in the partition information storage 236.

Referring to FIG. 3A, content 300 is partitioned into multiple unit blocks, and each of the multiple unit blocks is a unit of 16 bits, that is, 16-bit bit strings. As shown in FIG. 3A, numbers in each block respectively represent indexes allocated to the corresponding unit blocks. As shown in FIG. 3A, for example, indexes sequentially increasing by one from 0 to 47 are allocated to the successive unit blocks. However, the partition processor 220 may use a different method to allocate indexes to unit blocks. In FIG. 3A, unit blocks corresponding to indexes 1, 9, 16, 20, 30, and 41 are randomly chosen as first content parts and may be stored in the terminal 110, and the remaining unit blocks are selected as second content parts and stored in the server 120. The content partition method described above with reference to FIG. 3A may be applied to content which requires a highest security level since any word cannot be recovered if data leakage of the second content parts occurs from the server 120 due to hacking, or the like.

Further, each unit block may be partitioned into a first unit block portion and a second unit block portion. First unit block portions of all unit blocks may be the first content part, and second unit block portions of all unit blocks may be the second content part. As shown in FIG. 3A, content 300 may be partitioned into multiple unit blocks each having indexes from 0 to 47, and each of the multiple unit blocks may have a determined number of bits (i.e., 16 bits for each unit block) as shown in FIG. 3B. A portion of bit numbers may be randomly selected and the data bits of each unit block corresponding to the randomly selected bit numbers may be partitioned into the first unit block portion.

Referring to FIG. 3B, for example, bit numbers bit3, bit4, bit11, bit12, and bit13 may be randomly selected among 16 bits (from bit0 to bit15). Then, first unit block portions, bit data of every unit block corresponding to bit numbers bit3, bit4, bit11, bit12, and bit13, may be partitioned into the first content part. Second unit block portions, bit data of every unit block corresponding to bit numbers bit0, bit1, bit2, bit5, bit6, bit7, bit8, bit9, bit10, bit14, and bit15, may be partitioned into the second content part. The randomly chosen bit numbers bit3, bit4, bit11, bit12, and bit13 may be referred to as random bit numbers.

The random bit numbers may be selected for the second content part rather than the first content part, or for both the first content part and the second part. Information about random bit numbers for the first content part and/or random bit numbers for the second content part may be stored in the partition information storage 236 as partition information. Using this method, a single unit block may not be recovered by just acquiring the second content part without acquiring the first content part and the partition information.

FIG. 4 is a view illustrating a method for partitioning content according to an exemplary embodiment of the present invention.

If content 400 is classified as a security level “middle”, the partition processor 220 may partition the content into multiple second unit blocks. The second unit block may have a unit size larger than a word unit. The partition processor 220 may determine one or more unit blocks of the second unit blocks as first content parts. For example, the second unit block may have a size of 3 or more bytes, 1 KB, 10 KB, etc. Then, as described above with reference to FIG. 3A, the partition processor 220 may allocate indexes to the second unit blocks, respectively, and determine at least one second unit block corresponding to an index that is an arbitrary random number, as a first content part. For example, indexes 1, 5, and 9 may be randomly selected, and second unit blocks having an index corresponding to the randomly selected indexes, block 1, block 5, and block 9, may be partitioned as a first content part, and the remaining blocks may be partitioned as a second content part. The randomly selected block indexes may be referred to as random block indexes. The random block indexes may be selected for the second content part rather than the first content part, or for both the first content part and the second part. Information about random block indexes for the first content part and/or random block indexes for the second content part may be stored in the partition information storage 236 as partition information.

The partition processor 220 stores partition information including the size of the second unit block and index information of second unit blocks that are to be stored in the terminal 110 and the server 120 in the partition information storage 236.

FIG. 5 is a view illustrating a method for partitioning content according to an exemplary embodiment of the present invention.

If content 500 is classified as a security level “low”, the partition processor 220 may partition the content 500 into two blocks, and determine a block among the blocks as a first content part. Further, the partition processor 220 may partition the content 500 into two blocks, and then store the front block having the smaller size in the terminal 110 and the remaining block in the server 120. For example, if content is partitioned into two blocks that correspond to a header including metadata and a body including actual data, the header may be stored in the terminal 110 and the body may be stored in the server 120. The size of a block that is stored in the terminal 110 may be selected by a user of the terminal 110.

If the content 500 is partitioned into two blocks, the partition processor 220 may store information regarding the sizes of blocks that are respectively stored in the terminal 110 and the server 120 as partition information. A content security apparatus including the partition determining unit 210, the partition processor 220, the storage 230, and the communication unit 240 for partition with security of content may be included in the terminal 110, or may be implemented to be included in the server 120 so that the server 120 can partition content as well as store the partitioned content. As such, the server 120 may perform the content partitioning methods described above, like the terminal 110.

Meanwhile, the server 120 may receive partition reference information from the terminal 110 to partition content. The partition reference information may be used to partition content by the server 120.

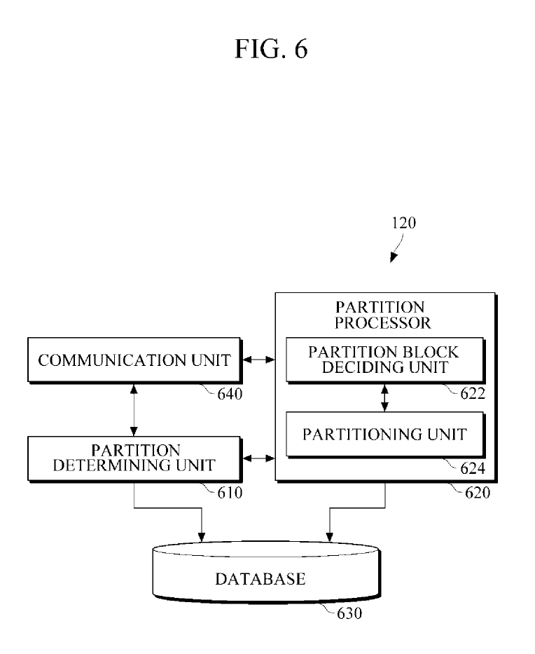

FIG. 6 is a diagram illustrating a cloud server according to an exemplary embodiment of the present invention.

Referring to FIG. 6, the server 120 includes a partition determining unit 610, a partition processor 620, a database 630, and a communication unit 640.

The partition determining unit 610 determines whether to partition content. The content to be partitioned may be received from the terminal 110 through the communication unit 640. Further, content to be partitioned may be created by the server 120 so that the terminal 110 can download the content from the server 120.

The partition processor 620 may partition the content in response to a content partition request message from the terminal 110. The terminal 110 may include partition reference information and the partition reference information may be transmitted to the server 120 through the content partition request message, or another message. The partition reference information may include information regarding a security level of the content, and an algorithm for a content partitioning method corresponding to the security level. The partition reference information may include other information for partitioning content, such as an index allocation method.

The partition processor 620 may partition the content into a first content part and a second content part according to the security level received from the terminal 110 and the algorithm for the content partitioning method corresponding to the security level. The first content part may be stored in the terminal 110 and the second content part may be stored in the server 120. The partition processor 620 may include a partition block deciding unit 622 and a partitioning unit 624. The partition block deciding unit 622 determines a size of a unit block for content to be partitioned according to a security level included in the partition reference information, and determines which unit blocks of the content are classified into a first content part and which unit blocks of the content are classified into a second content part. The partitioning unit 624 partitions the content based on the determinations of the partition block deciding unit 622.

After the content is partitioned by the partition processor 620, partition information is created. The partition information may be transmitted to and stored in the terminal 110, or the partition information may be partitioned and then each portion of the partition information may be stored in the terminal 110 and the database 630, respectively.

The database 630 stores the second content part among the first and second content parts partitioned according to a request from the terminal 110. If the server 120 is shared by a plurality of terminals, the database 630 allocates a plurality of storage areas to each of the terminals and manages the storage areas.

The server 120 and the terminal 110 may include an authentication unit (not shown). For data access security, the authentication unit of the terminal 110 and the authentication unit of the server 120 may generate an authentication protocol to authenticate with each other when partitioning content or a data file. The authentication protocol may be included in the partition information.

The authentication protocol may be unique for each partitioned data file. For example, the authentication protocol may be identification information of the terminal 110, identification information of the server 120, size information of unit block, random block indexes, random bit numbers, and the like. The identification information of the terminal 110 and the identification information of the server 120 may indicate corresponding content is partitioned (into first content part and second content part) by the terminal 110 or the server 120 and separately stored in the terminal 110 and the server 120. The random block indexes and random bit numbers are unique for corresponding partitioned content, thereby enhancing security of the content. If the terminal 110 partitions first content and second content. Partition information for the first content may include first authentication protocol, and partition information for the second content may include second authentication protocol which is different from the first authentication protocol.

Thus, the terminal 110 may access to the second content part stored in the server 120 if the server 120 authenticates the terminal 110 using the authentication protocol. For example, the authentication unit of the server 120 may authenticate the terminal 110 or a user of the terminal 110 by confirming identification, if the terminal 110 requests an access to the second content part. The second content part stored in an assigned storage area of the database 630 for the terminal 110 may be accessed by the terminal 110 only. The server 120 may identify the terminal 110 if the server 120 receives a partitioned content request message to retrieve the second content part stored in an assigned storage area of the database 630 for the terminal 110. The server 120 may request terminal identification information in response to the partitioned content request message. For example, the server 120 may identify the physical address of the terminal 110 by analyzing the terminal identification information. Thus, other terminals may not access to the second content part, even though partition information and the first content part stored in the terminal 110 are acquired by other terminals. The second content part stored in an assigned storage area of the database 630 for a specific user may be accessed by the specific user only. The server 120 may identify identification information included in Universal Subscriber Identity Module (USIM) if the terminal 110 is a mobile device. If a user inserts a USIM card to a new mobile terminal, the user may retrieve the second content part after authenticating identification information of the USIM card. Further, other terminals may not access to the second content part without having an access password to the server 120, even though partition information and the first content part stored in the terminal 110 are acquired by other terminals. In addition, the database 630 may store the partition reference information received from the terminal 110.

The partition reference information may be used when content is partitioned in response to a content partition request message from the terminal 110. The server 120 may determine a security level and a partitioning method based on the partition reference information.

The communication unit 640 interfaces with a network 10 to communicate with the terminal 110. The communication unit 640 may receive the content partition request message, content to be partitioned, the partition reference information, and the like from the terminal 110, and transmit the first content part and partition information to the terminal 110.

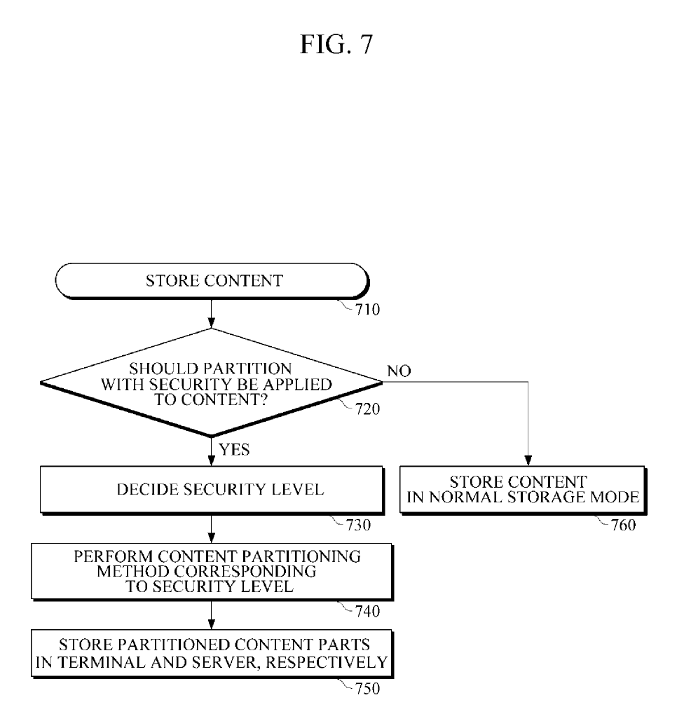

FIG. 7 is a flowchart illustrating a method for partitioning content according to an exemplary embodiment of the present invention.

The content partitioning method may be performed by a content security apparatus that can be implemented in the terminal 110, the server 120, or other device. In the following description, it may be assumed that the terminal 110 performs the content partitioning method; however, the present invention is not limited thereto. If a user completes a content generating operation, such as creating content, correcting content, downloading content, etc. and stores the content in operation 710, the terminal 110 may determine whether to perform an operation for partition with security.

First, the terminal 110 determines whether to apply partition with security to the content to be stored in operation 720. The terminal 110 may determine whether to apply partition with security to the content, based on one or more partition conditions. The partition conditions may include at least one of content characteristics and a state of a content security apparatus (for example, the terminal 110). The content characteristics may include at least one of a content type, time information of the storage of content, content price, content's author, content size, and content name. The state of the content security apparatus may include at least one of a current location of the content security apparatus and the type of a network which the content security apparatus uses.

If the terminal 110 determines that partition with security is to be applied, the terminal 110 may determine a security level in operation 730.

If all of the partition conditions for determining a security level to be applied to the content are not activated, the terminal 110 may determine a security level of the content, using activated partition conditions among the partition conditions. Further, if each of the partition conditions has a weight, the terminal 110 may determine a security level of the content to be stored by calculating a security value using weights of satisfied partition conditions. In this case, if content satisfies two or more partition conditions, the terminal 110 may calculates a security value based on the satisfied partition conditions. The security value may be the highest value among weights of the satisfied partition conditions or may be the sum of the weights of the satisfied partition conditions.

A higher security level may be applied to content that satisfies more partition conditions among all partition conditions. Further, a higher security level may be applied to content having a greater sum of weights of satisfied partition conditions.

The terminal 110 performs a content partitioning method corresponding to the determined security level in operation 740, thereby partitioning the content into a first content part and a second content part. The first content part may be stored in the terminal 110 and the second content part may be stored in the server 120. Also, partition information for the partitioned content is created and be stored in the terminal 110.

The terminal 110 stores the first content part and stores the second content parts in the server 120 in operation 750. The partition information may be stored in the terminal 110 or in both the terminal 110 and the server 120 after partitioning the partition information. That is, the partition information also may be partitioned and stored in the terminal 110 and the server 120.

If partition with security is not to be applied to the content to be stored, the terminal 110 enters into the normal storage mode to store the content without partitioning in operation 760. The content may be stored in the terminal 110 or in the server 120 as a whole.

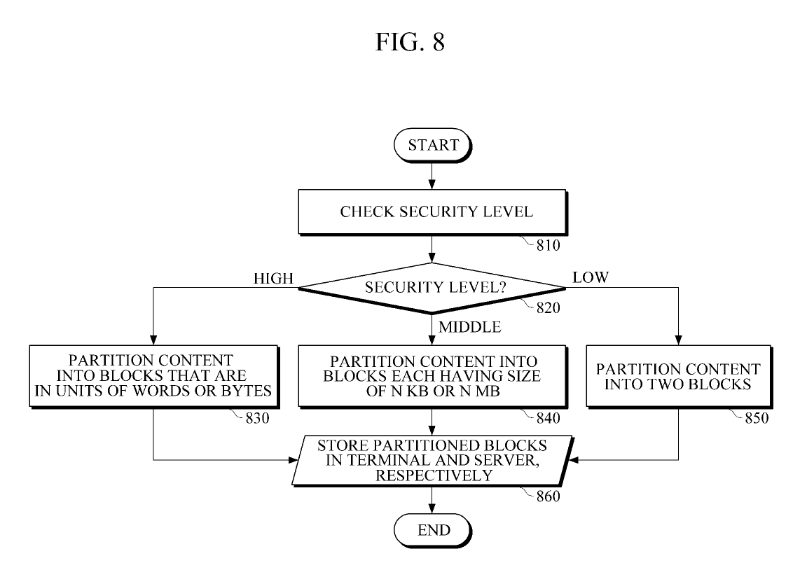

FIG. 8 is a flowchart illustrating a method for partitioning content based on a security level according to an exemplary embodiment of the present invention.

In operation 810, the terminal 110 checks a security level determined in operation 730 of FIG. 7.

If the security level is “high” in operation 820, the terminal 110 partitions the content into unit blocks, such as units of words or bytes, and then classifies the blocks in operation 830. When classifying the blocks, the terminal 110 extracts blocks having indexes corresponding to random numbers generated by a random number generator, and classifies the extracted blocks as a first content part and the remaining blocks as a second content part. Partition information, such as information about a size of a unit block, block index information (or an arrangement order of unit blocks) of the first content part, block index information (or an arrangement order of unit blocks) of the second content part, etc., is created.

If the security level is “middle” in the operation 820, the terminal 110 may partition the content into N kilobytes (KB) or N megabytes (MB) of unit blocks in operation 840. Each of the unit blocks may have size larger than the unit block generated in the operation 830. The terminal 110 extracts blocks having indexes corresponding to random numbers generated by the random number generator, and classifies the extracted blocks as a first content part and the remaining blocks as a second content part. Partition information, such as information about a size of a unit block, block index information (or an arrangement order of unit blocks) of the first content part, block index information (or an arrangement order of unit blocks) of the second content part, etc., is created.

If the security level is “low” in the operation 820, the terminal 110 partitions the content into two blocks in operation 850. The size of each block may depend on a content partitioning method. Information about the size of the block may be generated as partition information. Then, each of the two blocks is stored in the terminal 110 and the server 120, respectively in operation 860.

As such, by extracting blocks having indexes corresponding to random numbers generated by a random number generation method when content is stored or when content is updated and stored, the indexes of blocks that are to be partitioned into first and second content parts may be changed, thus security of the content may be enhanced.

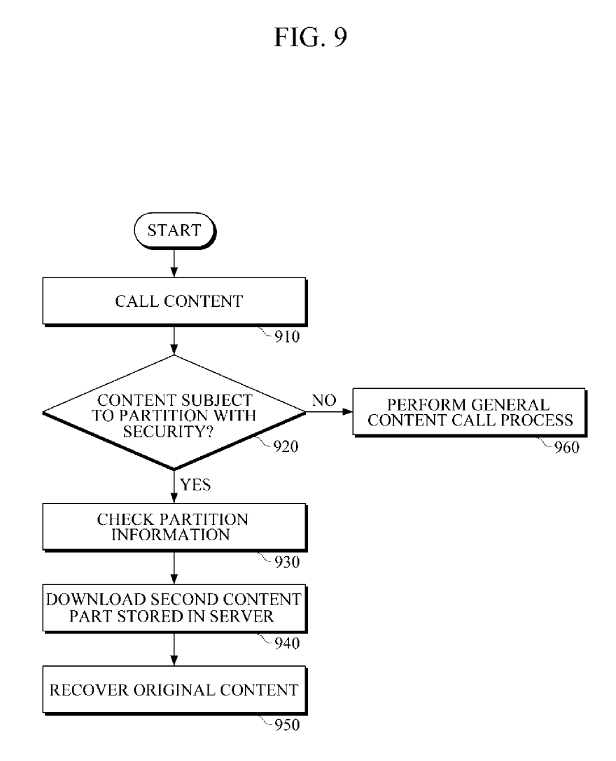

FIG. 9 is a flowchart illustrating a method for recovering partitioned content according to an exemplary embodiment of the present invention.

If content is retrieved by an application in operation 910, the terminal 110 determines whether the retrieved content is to be applied partition with security before storing the content in operation 920. If the content is not to be applied partition with security, a general content retrieval process may be performed in operation 960.

If the content is determined to be partitioned with security in operation 920, the terminal 110 retrieves partition information of the corresponding content in operation 930. The terminal 110 may search for partition information stored in a memory of the terminal 110 to retrieve partition information. If the partition information is partitioned and portions of the partition information are stored in the terminal 110 and the server 120, respectively, the terminal 110 requests the server 120 to send a portion of the partition information corresponding to the content.

Then, the terminal 110 requests the server 120 to send a second content part, based on the partition information, and downloads the second content part from the server 120 in operation 940. The partition information may serve as a key to request the second content part. Further, both the partition information and the terminal identification information may serve as keys to request the second content part to ensure security. For example, a random bit number and identification of a mobile terminal, i.e. International Mobile Equipment Identity number (IMEI), may be combined and serve as a key to request the second content part.

The terminal 110 may combine the second content part and a first content part corresponding to the second content part to recover original content existed before partitioning in operation 950. As described above, the process of recovering content is performed based on partition information. Since the partition information may be generated by a protocol according to a content partitioning method corresponding to a security level of the content, the process of recovering the content also may be performed by a corresponding content recovering method.

The recovered content may be provided to a user through the application that has called for the content. Also, the recovered content may be stored in an internal memory of the terminal 110 according to a user's input.

Further, the process of recovering content may be performed by the server 120. In this scheme, the terminal 110 may transmit a content recovery request message to the server 120. That is, the terminal 110 may transmit partition information and the first content part to the server 120, and the server 120 may recover original content existed before partitioning using the received partition information, the first content part, and a second content part stored in a storage area of the server 120. The terminal 110 may download the recovered content from the sever 120.

A user may allow the server 120 to delete the unnecessary content by transmitting a list of the unnecessary content or partition information about the second content part to the server 120, if the user has an authority for the second content part. The server 120 may allow the terminal 110 to download the second content part before deleting it. In this case, the server 120 may send a message to the terminal 110 about whether a user wants to download the second content part.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

According to exemplary embodiments of the present invention, by using a data partitioning process for protecting private information of a user, a recovery of original data may not be possible even though data leakage from a server occurs. Moreover, different security levels may be applied in partitioning data according to the characteristics of the data.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. An apparatus to process partitioned data, comprising:
a storage unit to store a first data portion of a data file;
a communication unit to receive a second data portion of the data file from a separate device in response to an authentication between the apparatus and the separate device; and
a recovery processing unit to obtain the data file, by merging the first data portion and the second data portion of the data file using partition information.

2. The apparatus of claim 1, further comprising a partition processing unit to partition the data file into the first data portion and the second data portion, and to generate the partition information according to a partitioning method, and
wherein the communication unit transmits the second portion of the data file to the separate device.

3. The apparatus of claim 2, further comprising a partition determining unit to determine whether to partition the data file based on a partition condition,
wherein the partition processing unit divides the data file into multiple unit blocks and generates index information for each of the multiple unit blocks, and
the partition information comprises size information of the multiple unit blocks.

4. The apparatus of claim 3, wherein the partition processing unit determines a security level based on the partition condition,
the partition processing unit classifies the multiple unit blocks into the first data portion and the second data portion according to the security level, and
the partition information further comprises index information for one or more unit blocks included in the first data portion or index information for one or more unit blocks included in the second data portion.

5. The apparatus of claim 3, wherein the partition processing unit determines a security level based on the partition condition,
the partition processing unit divides each of the multiple unit blocks into a first unit block portion and a second unit block portion according to the security level,
the first unit block portions of each of the multiple unit blocks are stored in the storage unit as the first data portion and the second unit block portions of each of the multiple unit blocks are stored in the separate device as the second data portion, and
the partition information comprises division information of the first unit block portion and the second unit block portion.

6. The apparatus of claim 5, wherein the division information of the first unit block portion and the second unit block portion comprises bit number information for the first unit block portion and bit number information for the second unit block portion.

7. The apparatus of claim 1, wherein the communication unit receives the second data portion of the data file from the separate device, if identification of the apparatus is authenticated by the separate device.

8. The apparatus of claim 7, wherein identification data stored in a universal subscriber identity module of the apparatus is authenticated by the separate device.

9. The apparatus of claim 3, wherein the partition condition comprises at least one of a content type, time information of a storage of content, content price, content size, author of content, content name, location information of the apparatus, and available network type.

10. The apparatus of claim 9, wherein each partition condition has a weight.

11. A server to process partitioned data, comprising:
a storage unit to store a first data portion of a data file;
a communication unit to receive identification information of a terminal, and to transmit the first data portion of the data file to the terminal in response to an authentication of the terminal; and
an authentication unit to authenticate the identification information of the terminal.

12. The server of claim 11, further comprising a recovery processing unit to merge the first data portion and a second data portion of the data file using partition information,
wherein the communication unit receives the second data portion of the data file and the partition information from the terminal and transmits the data file to the terminal.

13. The server of claim 11, further comprising a partition processing unit to partition the data file into the first data portion and the second data portion, and to generate the partition information according to a partitioning method, and
wherein the communication unit transmits the second portion of the data file and the partition information to the terminal.

14. The server of claim 13, wherein the partition processing unit partitions the data file into the first data portion and the second data portion base on a first partition condition, and
the partitioning method is determined based on a second partition condition.

15. The server of claim 13, wherein the partition processing unit divides the data file into multiple unit blocks and generates index information for each of the multiple unit blocks,
the first data portion comprises at least one unit block among the multiple unit blocks having index information corresponding to a randomly selected index number, and
the partition information comprises size information of the multiple unit blocks and the randomly selected index number.

16. A method for processing partitioned data, comprising:
partitioning the data file into a first data portion and a second data portion;
generating partition information used for merging the first data portion and the second data portion, based on a partitioning method; and
storing the first data portion in a first storage and storing the second data portion in a second storage,
wherein the partition information comprises an authentication protocol between the first storage and the second storage.

17. The method of claim 16, further comprising:
determining whether to partition a data file according to a first partition condition; and
determining a security level based on a second partition condition.

18. The method of claim 16, wherein the first storage is included in a terminal and the second storage is included in a server,
the authentication protocol comprises identification information of the server and identification information of the terminal.

19. The method of claim 16, wherein the authentication protocol comprises at least one of a random block index, and a random bit number, and
the random block index and the random bit number are used to distinguish the first data portion from the second data portion among multiple unit blocks of the data file.

20. The method of claim 17, wherein the first partition condition comprises at least one of a content type, time information of a storage of content, content price, content size, author of content, content name, location information of the apparatus, and available network type.
